(19) United States
(12) Patent Application Publication
(10) Pub. No.: US 2015/0127782 A1
(43) Pub. Date: May 7, 2015

(54) Video Conference Recording Method, Device, and System

(71) Applicant: Huawei Technologies Co., Ltd., Shenzhen (CN)

(72) Inventors: Yongning Qin, Shenzhen (CN); Min Xiao, Shenzhen (CN)

(21) Appl. No.: 14/597,666

(22) Filed: Jan. 15, 2015

Related U.S. Application Data
(63) Continuation of application No. PCT/CN2013/076642, filed on Jun. 3, 2013.

(30) Foreign Application Priority Data
Sep. 24, 2012 (CN) 201210358088.5

(51) Int. Cl. H04L 29/06

(52) U.S. Cl. CPC H04L 65/403; H04L 65/60
USPC 709/219

(57) ABSTRACT

A video conference recording method, device, and system, which can implement recording and playback of a video of a conference according to a user requirement when the video conference is in progress. The method includes receiving a playback request message input by a user; sending the playback request message to a recording server, so that the recording server selects recorded streaming media information according to the playback request message; receiving a combination data stream sent by the recording server, where the combination data stream includes at least one channel of the streaming media information that is selected, and each of the at least one channel of the streaming media information is corresponding to one conference site; and displaying the at least one channel of the streaming media information that is received. The embodiments of the present invention are used to implement recording of a video conference.

### CROSS-REFERENCE TO RELATED APPLICATION

This application is a continuation of International Application No. PCT/CN2013/076642, filed on Jun. 3, 2013, which claims priority to Chinese Patent Application No. 201210358088.5, filed on Sep. 24, 2012, both of which are hereby incorporated by reference in their entireties.

### TECHNICAL FIELD

The present invention relates to the field of communications, and in particular, to a video conference recording method, device, and system.

### BACKGROUND

With development of video encoding technologies and information compression technologies and gradual popularization of digital networks, a video conference system for performing synchronous video transmission using a digital network has gradually gained recognition from people. In the early 1990s, the first set of international standards H.320 relating to a video conference system were approved, so that a problem of compatibility between products of different brands was resolved, and a video conference system based on a traditional telecommunication network, such as an integrated services digital network (ISDN), became a main trend in the video conference product market. In the middle and late 1990s, as Internet Protocol (IP) network technologies gradually matured, IP network development became an important network platform of global communication. In 1998, the International Telecommunication Union-Telecommunication Standardization Sector (ITU-T) issued IP network-based H.323 video conference standards, so that research and application orientations of the video conference system gradually shifted to an IP network-based development orientation.

In recent years, with further development of the IP network technologies and video compression technologies, the video conference system is more widely applied. In actual application, a user usually has a requirement for recording a conference process, that is, recording conference content for information storage or future playback. Especially when a video conference is in progress, if the user requires playback of a conference process video of a previous moment, the prior art cannot support this requirement.

### SUMMARY

Embodiments of the present invention provide a video conference recording method, device, and system, to implement recording and playback of a video of a conference according to a user requirement when the video conference is in progress.

To achieve the foregoing objective, the following technical solutions are adopted in the embodiments of the present invention.

According to one aspect of the embodiments of the present invention, a video conference recording method is provided and includes receiving a playback request message input by a user; sending the playback request message to a recording server, so that the recording server selects recorded streaming media information according to the playback request message; receiving a combination data stream sent by the recording server, where the combination data stream includes at least one channel of the streaming media information that is selected, and each of the at least one channel of the streaming media information is corresponding to one conference site; and displaying the streaming media information included in the received combination data stream.

The receiving a playback request message input by a user includes receiving the playback request message input by the user in a display area of a user terminal, where the display area of the user terminal includes at least one pane, and each of the at least one pane is used to display an image of one conference site.

The playback request message includes streaming media identifier information and playback location information, where the streaming media identifier information includes conference site identifier information of a conference site that participates in a conference or pane identifier information corresponding to the conference site that participates in the conference; and the recording server selects a conference site whose streaming media information requires playback according to the streaming media identifier information and selects, according to the playback location information, streaming media information that requires playback from recorded streaming media information of the conference site.

Before the receiving a playback request message input by a user, the method further includes receiving the streaming media identifier information sent by the recording server.

The displaying the streaming media information included in the received combination data stream includes when the streaming media identifier information includes identifier information of a first pane or conference site identifier information of a first conference site corresponding to the first pane, displaying, in the first pane of the display area of the user terminal, first streaming media information that is received and corresponding to the identifier information of the first pane or the conference site identifier information of the first conference site; or when the streaming media identifier information is identifier information of a first pane or conference site identifier information of a first conference site corresponding to the first pane, displaying, in the display area of the user terminal, first streaming media information that is received and corresponding to the identifier information of the first pane or the conference site identifier information of the first conference site; or when the streaming media identifier information includes identifier information of a first pane or conference site identifier information of a first conference site corresponding to the first pane, and second pane identifier information or conference site identifier information of a second conference site corresponding to a second pane, displaying, in the first pane of the display area of the user terminal, first streaming media information that is received and corresponding to the identifier information of the first pane or the conference site identifier information of the first conference site; and synchronously displaying, in the second pane of the display area of the user terminal, second streaming media information that is received and corresponding to the second pane identifier information or the conference site identifier information of the second conference site.

The streaming media information includes at least one type of the following information: video information, audio information, image information, and subtitle information.

According to another aspect of the embodiments of the present invention, a video conference recording method is provided and includes obtaining a playback request message; selecting streaming media information according to the playback request message; combining at least one channel of the streaming media information that is selected into a combination data stream, where each of the at least one channel of the streaming media information is corresponding to one conference site; and sending the combination data stream to at least one user terminal.

The obtaining a playback request message includes receiving the playback request message sent by the at least one user terminal; or obtaining the playback request message input by a user in a display area of a recording server, where the display area of the recording server includes at least one pane, and each of the at least one pane is used to display an image of one conference site.

After the selecting streaming media information according to the playback request message, the method further includes displaying the streaming media information that is selected and included in the combination data stream.

The playback request message includes streaming media identifier information and playback location information, where the streaming media identifier information includes conference site identifier information of a conference site that participates in a conference or pane identifier information corresponding to the conference site that participates in the conference; and the selecting streaming media information according to the playback request message is selecting a conference site whose streaming media information requires playback according to the streaming media identifier information and selecting, according to the playback location information, streaming media information that requires playback from recorded streaming media information of the conference site.

Before the obtaining a playback request message, the method further includes sending the streaming media identifier information to the at least one user terminal.

The displaying the streaming media information that is selected and included in the combination data stream includes when the streaming media identifier information includes identifier information of a first pane or conference site identifier information of a first conference site corresponding to the first pane, displaying, in the first pane of the display area of the recording server, first streaming media information that is selected and corresponding to the identifier information of the first pane or the conference site identifier information of the first conference site; or when the streaming media identifier information is identifier information of a first pane or conference site identifier information of a first conference site corresponding to the first pane, displaying, in the display area of the recording server, first streaming media information that is selected and corresponding to the identifier information of the first pane or the conference site identifier information of the first conference site; or when the streaming media identifier information includes identifier information of a first pane or conference site identifier information of a first conference site corresponding to the first pane, and second pane identifier information or conference site identifier information of a second conference site corresponding to a second pane, displaying, in the first pane of the display area of the recording server, first streaming media information that is selected and corresponding to the identifier information of the first pane or the conference site identifier information of the first conference site; and synchronously displaying, in the second pane of the display area of the recording server, second streaming media information that is selected and corresponding to the second pane identifier information or the conference site identifier information of the second conference site.

The streaming media information includes at least one type of the following information: video information, audio information, image information, and subtitle information.

According to another aspect of the embodiments of the present invention, a user terminal is provided and includes a receiver configured to receive the playback request message input by a user; a sender configured to send the playback request message to a recording server, so that the recording server selects recorded streaming media information according to the playback request message, where the receiver is further configured to receive a combination data stream sent by the recording server, where the combination data stream includes at least one channel of the streaming media information that is selected, and each of the at least one channel of the streaming media information is corresponding to one conference site; and a display area of the user terminal configured to display the streaming media information included in the received combination data stream.

The receiver is further configured to receive the playback request message input by the user in the display area of the user terminal, where the display area of the user terminal includes at least one pane, and each of the panes is used to display an image of one conference site.

The playback request message includes streaming media identifier information and playback location information, where the streaming media identifier information includes conference site identifier information of a conference site that participates in a conference or pane identifier information corresponding to the conference site that participates in the conference; and the recording server selects a conference site whose streaming media information requires playback according to the streaming media identifier information and selects, according to the playback location information, streaming media information that requires playback from recorded streaming media information of the conference site.

The display area of the user terminal is further configured to, when the streaming media identifier information includes identifier information of a first pane or conference site identifier information of a first conference site corresponding to the first pane, display, in the first pane of the display area of the user terminal, first streaming media information that is received and corresponding to the identifier information of the first pane or the conference site identifier information of the first conference site; or when the streaming media identifier information is identifier information of a first pane or conference site identifier information of a first conference site corresponding to the first pane, display, in the display area of the user terminal, first streaming media information that is received and corresponding to the identifier information of the first pane or the conference site identifier information of the first conference site; or when the streaming media identifier information includes identifier information of a first pane or conference site identifier information of a first conference corresponding to the first pane, and second pane identifier information or conference site identifier information of a second conference site corresponding to a second pane, display, in the first pane of the display area of the user terminal, first streaming media information that is received and corresponding to the identifier information of the first pane or the conference site identifier information of the first conference site; and synchronously display, in the second pane of the display area of the user terminal, second streaming media information that is received and corresponding to the second pane identifier information or the conference site identifier information of the second conference site.

According to another aspect of the embodiments of the present invention, a recording server is provided and includes a receiver configured to obtain a playback request message; a processor configured to select streaming media information according to the playback request message, where the processor is further configured to combine at least one channel of the streaming media information that is selected into a combination data stream, where each of the at least one channel of the streaming media information is corresponding to one conference site; and a sender configured to send the combination data stream to at least one user terminal.

The receiver is further configured to receive the playback request message sent by the at least one user terminal; or obtain the playback request message input by a user in a display area of the recording server, where the display area of the recording server includes at least one pane, and each of the at least one pane is used to display a real-time image of one conference site.

The playback request message includes streaming media identifier information and playback location information, where the streaming media identifier information includes conference site identifier information of a conference site that participates in a conference or pane identifier information corresponding to the conference site that participates in the conference; and the processor is configured to select a conference site whose streaming media information requires playback according to the streaming media identifier information and select, according to the playback location information, streaming media information that requires playback from recorded streaming media information of the conference site.

The display area of the recording server is further configured to, when the streaming media identifier information includes identifier information of a first pane or conference site identifier information of a first conference site corresponding to the first pane, display, in the first pane of the display area of the recording server, first streaming media information that is selected and corresponding to the identifier information of the first pane or the conference site identifier information of the first conference site; or when the streaming media identifier information is identifier information of a first pane or conference site identifier information of a first conference site corresponding to the first pane, display, in the display area of the recording server, first streaming media information that is selected and corresponding to the identifier information of the first pane or the conference site identifier information of the first conference site; or when the streaming media identifier information includes identifier information of a first pane or conference site identifier information of a first conference site corresponding to the first pane, and second pane identifier information or conference site identifier information of a second conference site corresponding to a second pane, display, in the first pane of the display area of the recording server, first streaming media information that is selected and corresponding to the identifier information of the first pane or the conference site identifier information of the first conference site; and synchronously display, in the second pane of the display area of the recording server, second streaming media information that is selected and corresponding to the second pane identifier information or the conference site identifier information of the second conference site.

According to still another aspect of the embodiments of the present invention, a video conference recording system is provided and includes at least one user terminal as stated above, and the foregoing recording server.

According to the video conference recording method, device, and system provided in the embodiments of the present invention, a playback request message input by a user is received, and the playback request message is sent to a recording server; the recording server can select streaming media information according to the playback request message; and after receiving a combination data stream sent by the recording server, a user terminal displays the at least one channel of the streaming media information that is received, where the combination data stream includes the at least one channel of the streaming media information, and each of the at least one channel of the streaming media information is corresponding to one conference site. When recording and playback of a video conference are performed using the method, recording and playback of a video of the conference can be implemented according to a user requirement when the video conference is in progress, thereby improving user experience.

### BRIEF DESCRIPTION OF DRAWINGS

To describe the technical solutions in the embodiments of the present invention more clearly, the following briefly introduces the accompanying drawings required for describing the embodiments. The accompanying drawings in the following description show merely some embodiments of the present invention, and a person of ordinary skill in the art may still derive other drawings from these accompanying drawings without creative efforts.

FIG. 1 is a schematic flowchart of a video conference recording method according to an embodiment of the present invention;

FIG. 2 is a schematic flowchart of another video conference recording method according to an embodiment of the present invention;

FIG. 3 is a schematic diagram of a signaling procedure of another video conference recording method according to an embodiment of the present invention;

FIG. 4 is a schematic diagram of a display image of a user terminal according to an embodiment of the present invention;

FIG. 5 is a schematic diagram of a display image of another user terminal according to an embodiment of the present invention;

FIG. 6 is a schematic diagram of a display image of another user terminal according to an embodiment of the present invention;

FIG. 7 is a schematic diagram of a display image of another user terminal according to an embodiment of the present invention;

FIG. 8 is a schematic diagram of a display image of still another user terminal according to an embodiment of the present invention;

FIG. 9 is a schematic structural diagram of a user terminal according to an embodiment of the present invention;

FIG. 10 is a schematic structural diagram of another user terminal according to an embodiment of the present invention;

FIG. 11 is a schematic structural diagram of a recording server according to an embodiment of the present invention;

FIG. 12 is a schematic structural diagram of another recording server according to an embodiment of the present invention; and

FIG. 13 is a schematic structural diagram of a video conference recording system according to an embodiment of the present invention.

### DESCRIPTION OF EMBODIMENTS

The following clearly describes the technical solutions in the embodiments of the present invention with reference to the accompanying drawings in the embodiments of the present invention. The described embodiments are merely a part rather than all of the embodiments of the present invention. All other embodiments obtained by a person of ordinary skill in the art based on the embodiments of the present invention without creative efforts shall fall within the protection scope of the present invention.

A video conference recording method provided in an embodiment of the present invention relates to a user terminal. As shown in FIG. 1, the method includes the following steps:

S101: The user terminal receives a playback request message input by a user.

The playback request message may include streaming media identifier information and playback location information, where the streaming media identifier information may further include conference site identifier information of a conference site that participates in a conference or pane identifier information corresponding to the conference site that participates in the conference. A recording server may select a conference site whose streaming media information requires playback according to the streaming media identifier information and select, according to the playback location information, streaming media information that requires playback from recorded streaming media information of the conference site. For example, during a video conference, users participating in the video conference may be in multiple different conference sites, a screen of a user terminal of each user has multiple panes, and each pane is corresponding to one conference site. When needing to watch a historical image of a conference site before a current moment, a user may select, using a remote control or a touchscreen, streaming media identifier information of the target conference site and information about a playback location that requires recording and playback.

S102: The user terminal sends the playback request message to the recording server, so that the recording server selects recorded streaming media information according to the playback request message.

S103: The user terminal receives a combination data stream sent by the recording server, where the combination data stream includes at least one channel of the streaming media information that is selected, and each of the at least one channel of the streaming media information is corresponding to one conference site.

For example, when wanting to view historical images of two conference sites at the same time, the user selects streaming media identifier information of the two conference sites from the input playback request message, and selects required playback location information. After obtaining the playback request message, the recording server finds corresponding videos of the two conference sites according to the streaming media identifier information carried in the playback request message, extracts a video starting from a corresponding time point according to the playback location information, combines the selected two channels of streaming media information into a combination data stream, and sends the combination data stream to the user terminal that sends the request.

S104: The user terminal displays the streaming media information included in the received combination data stream.

The streaming media information may include at least one type of the following information: video information, audio information, image information, and subtitle information.

According to the video conference recording method provided in the embodiment of the present invention, a playback request message input by a user is received, and the playback request message is sent to a recording server; the recording server can select streaming media information according to the playback request message; and after receiving a combination data stream sent by the recording server, a user terminal displays at least one channel of streaming media information that is received, where the combination data stream includes the at least one channel of the streaming media information, and each of the at least one channel of the streaming media information is corresponding to one conference site. When recording and playback of a video conference are performed using the method, recording and playback of a video of the conference can be implemented according to a user requirement when the video conference is in progress, thereby improving user experience.

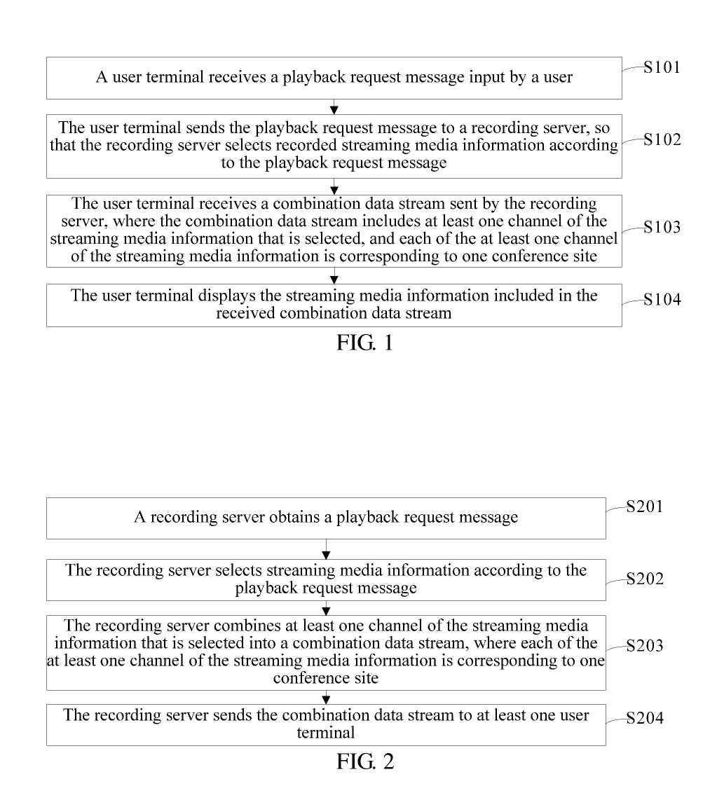

Correspondingly, a video conference recording method provided in an embodiment of the present invention relates to a recording server. As shown in FIG. 2, the method includes the following steps:

S201: The recording server obtains a playback request message.

The recording server may receive the playback request message sent by at least one user terminal; or when the recording server has a display area, the recording server may obtain the playback request message input by a user in the display area of the recording server, where the display area of the recording server includes at least one pane, and each pane is used to display a real-time image of one conference site. For a process during which the recording server obtains the playback request message input by the user in the display area of the recording server, reference may be made to a process during which a user terminal receives the playback request message input by a user.

S202: The recording server selects streaming media information according to the playback request message.

The playback request message may include streaming media identifier information and playback location information, where the streaming media identifier information may further include conference site identifier information of a conference site that participates in a conference or pane identifier information corresponding to the conference site that participates in the conference. The recording server may select a conference site whose streaming media information requires playback according to the streaming media identifier information and select, according to the playback location information, streaming media information that requires playback from recorded streaming media information of the conference site. For example, the recording server may select an image of a conference site that requires recording and playback according to the streaming media identifier information, and the recording server may also determine a start time point of a historical image that requires recording and playback according to the playback location information.

S203: The recording server combines at least one channel of the streaming media information that is selected into a combination data stream, where each of the at least one channel of the streaming media information is corresponding to one conference site.

S204: The recording server sends the combination data stream to at least one user terminal.

The streaming media information may include at least one type of the following information: video information, audio information, image information, and subtitle information.

According to the video conference recording method provided in the embodiment of the present invention, a playback request message input by a user is received, and the playback request message is sent to a recording server; the recording server can select streaming media information according to the playback request message; and after receiving a combination data stream sent by the recording server, a user terminal displays at least one channel of streaming media information that is received, where the combination data stream includes the at least one channel of the streaming media information, and each of the at least one channel of the streaming media information is corresponding to one conference site. When recording and playback of a video conference are performed using the method, recording and playback of a video of the conference can be implemented according to a user requirement when the video conference is in progress, thereby improving user experience.

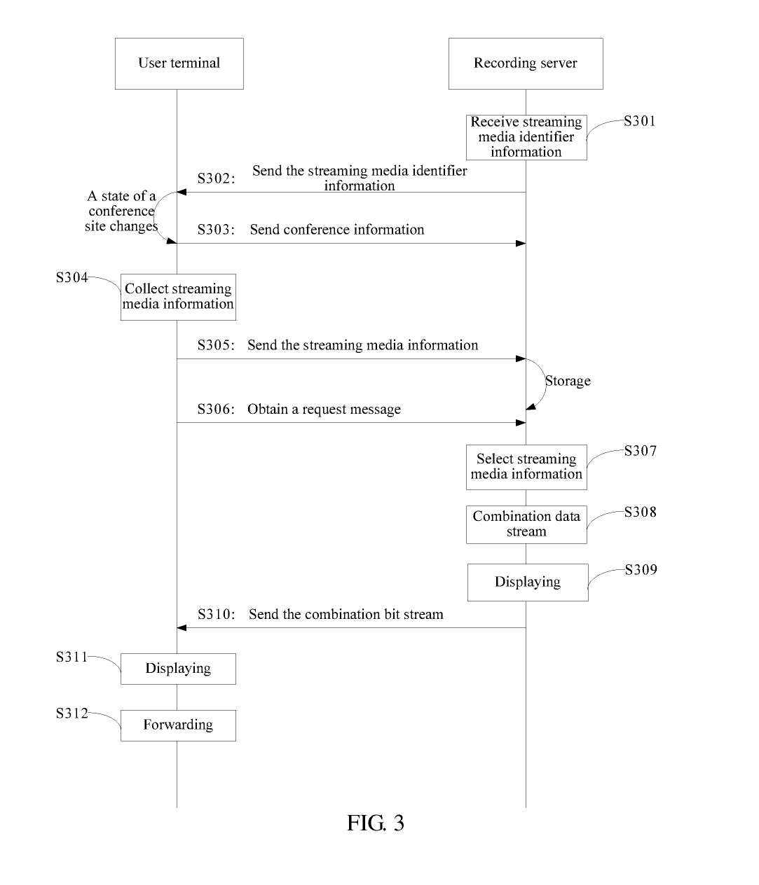

Further, a video conference recording method according to an embodiment of the present invention, as shown in FIG. 3, includes the following steps:

S301: A recording server receives streaming media identifier information.

Before a video conference starts, a user may preset a group of streaming media identifier information on the recording server according to historical experience or an estimated quantity of conference sites that participate in the video conference, so that the recording server monitors, in real time, at least one user terminal that records the streaming media identifier information. Alternatively, when a user terminal accesses a conference network, the recording server automatically generates a network topology, to obtain streaming media identifier information of all conference sites. In addition, the recording server may configure a recording policy according to the streaming media identifier information. For example, the recording server may select conference videos of all user terminals that record the streaming media identifier information.

S302: The recording server sends the streaming media identifier information to the at least one user terminal.

For example, if the streaming media identifier information includes streaming media identifier information of a conference site 1 to a conference site 9, after a user terminal receives the streaming media identifier information, in a display area of the user terminal, panes corresponding to the conference site 1 to the conference site 9 are in an enabled state. In this way, the user terminal can easily and quickly learn information about all conference sites that participate in the conference, and quickly establish a connection with the recording server, so that the user terminal can select, according to the streaming media identifier information and from all the conference sites that participate in the conference, streaming media information of a conference site whose streaming media information requires playback.

S303: When a state of a conference site changes, the user terminal sends conference information to the recording server, so that the recording server updates the streaming media identifier information.

The conference information may be used to indicate whether a current conference site participates in the conference, or may be used to indicate all streaming media that a current conference site can provide.

For example, if the at least one user terminal includes user terminals of the conference site 1 to the conference site 9 at an initial moment of the video conference, a user of the conference site 9 leaves the conference when the conference is in progress, and the user terminal of the conference site 9 disconnects a connection with other conference sites, the user terminal sends conference information to the recording server, where the conference information indicates that the user terminal of the conference site 9 has been disconnected. Alternatively, if the user of the conference site 9 leaves the conference for a period of time and then joins the conference again, when the user terminal of the conference site 9 accesses the network again, the user terminal also sends conference information to the recording server, where the conference information indicates that the user terminal of the conference site 9 has been connected, and the recording server may update the streaming media identifier information according to the conference information. In this way, the user terminal that has been disconnected may be prevented from continuing occupying a resource of the recording server.

S304: The user terminal collects an image and voice of a conference site accommodating a user, to obtain streaming media information.

For example, the user terminal may obtain, by collection with a camera, image information of the conference site accommodating the user; obtain, by collection with a microphone, voice information of the conference site accommodating the user; and combine the image information and the voice information according to same time, to form the streaming media information of the conference site.

S305: The recording server receives and stores the streaming media information sent by the at least one user terminal.

The streaming media information may include at least one type of the following information: video information, audio information, image information, and subtitle information.

S306: The recording server obtains a playback request message.

The recording server may receive the playback request message sent by the at least one user terminal; or when the recording server has a display area, the recording server may obtain the playback request message input by a user in the display area of the recording server, where the display area of the recording server includes at least one pane, and each pane is used to display a real-time image of one conference site.

It should be noted that, for a recording server that has a display area, the recording server may select streaming media information according to a playback request message obtained from a user terminal, and return the selected streaming media information to the user terminal that sends the request or perform playback in the display area of the recording server. Alternatively, the recording server may select streaming media information according to a playback request message input using a user terminal in the display area of the recording server, and send the selected streaming media information to the specified user terminal or perform playback in the display area of the recording server. For a process during which the recording server obtains the playback request message input by the user in the display area of the recording server, reference may be made to a process during which a user terminal receives a playback request message input by a user.

When the recording server receives the playback request message sent by the user terminal, the playback request message may include streaming media identifier information and playback location information, where the streaming media identifier information may further include conference site identifier information of a conference site that participates in a conference or pane identifier information corresponding to the conference site that participates in the conference. The streaming media identifier information in the playback request message may be streaming media identifier information that is selected by the user from the streaming media identifier information obtained by the user terminal and is corresponding to a conference site whose streaming media information requires playback. The recording server may select the conference site whose streaming media information requires playback according to the streaming media identifier information and select, according to the playback location information, streaming media information that requires playback from recorded streaming media information of the conference site.

S307: The recording server selects streaming media information according to the playback request message.

S308: The recording server combines at least one channel of the streaming media information that is selected into a combination data stream, where each of the at least one channel of the streaming media information is corresponding to one conference site.

The recording server with a data stream combination function may perform data stream combination using a data stream combining module of the recording server; or the recording server may send the at least one channel of the streaming media information that is selected to a conference multipoint control unit (MCU), and the conference MCU may combine the at least one channel of the streaming media information into the combination data stream.

The following method may be used to combine multiple channels of streaming media information to obtain a combination data stream, after the recording server selects at least one channel of streaming media information, calling a data stream combination resource; sending the multiple channels of streaming media information that need to be combined to a stream decoder of each sub-stream for decoding, to generate decoded information of the streaming media information; and combining decoded information of each sub-stream into a uniform combination data stream, and encoding the combination data stream.

For example, when the recording server selects multiple channels of streaming media information according to the playback request message input by the user, a combination subsystem of the recording server is triggered, and the combination subsystem delivers a combination command to a combination control module.

The combination control module analyzes the combination command, calls a combination resource management module, and allocates a processing resource. If the combination resource management module does not have sufficient resources for performing data stream combination, the combination control module reports an error indicating insufficient resources to the combination subsystem. If the combination resource management has sufficient resources, the combination control module calls a resource.

After obtaining the resource by calling, the combination control module delivers stream encoder and stream decoder scheduling commands to a stream processing control module of a related processing apparatus that is in the recording server and configured to perform data stream combination. After receiving the stream encoder and stream decoder scheduling commands, the stream processing control module of the related processing apparatus forwards the scheduling commands to a stream encoding module and a stream decoding module, to schedule a corresponding encoder and a corresponding decoder.

The combination control module sends an instruction to a stream switching module, to instruct the stream switching module to send the multiple channels of streaming media information that need to be combined to a stream processing module in which a stream decoder of each sub-stream of the combination data stream is located. For example, the multiple channels of streaming media information that need to be combined may be sent to a stream processing module in which a stream decoder of a pane of a combined video screen is located.

The stream processing module in which the stream decoder of each sub-stream of the combination data stream is located distributes the received streaming media information to the stream decoding module. The stream decoding module decodes a data stream of the streaming media information to generate decoded information of the streaming media information (for example, decoded information of video information is a decoded image, and decoded information of audio information is decoded audio data), and sends the decoded streaming media information to a corresponding stream processing module.

The stream processing module in which the stream decoder of each sub-stream of the combination data stream is located sends the received decoded streaming media information to a stream processing module in which an encoder of the combination data stream is located. The stream processing module distributes the decoded streaming media information to a stream encoding module of the combination data stream, combines data of each sub-stream into a uniform combination data stream, and encodes the combination data stream.

A combination data stream obtained after uniform encoding is stored inside the recording server, so that the recording server displays, or sends to the user terminal, information about the combination data stream.

In this way, one type of combination data stream may include multiple channels of streaming media information that are demanded by a user, which, for a video conference, can implement recording and playback of audio and video information of multiple conference sites under a precondition that bandwidth remains unchanged.

S309: The recording server displays the at least one channel of the streaming media information that is selected.

When the streaming media identifier information includes identifier information of a first pane or conference site identifier information of a first conference site corresponding to the first pane, first streaming media information that is selected and corresponding to the identifier information of the first pane or the conference site identifier information of the first conference site is displayed in the first pane of the display area of the recording server; or when the streaming media identifier information is identifier information of a first pane or conference site identifier information of a first conference site corresponding to the first pane, first streaming media information that is selected and corresponding to the identifier information of the first pane or the conference site identifier information of the first conference site is displayed in the display area; or when the streaming media identifier information includes identifier information of a first pane or conference site identifier information of a first conference site corresponding to the first pane, and second pane identifier information or conference site identifier information of a second conference site corresponding to a second pane, first streaming media information that is selected and corresponding to the identifier information of the first pane or the conference site identifier information of the first conference site is displayed in the first pane of the display area of the recording server; and second streaming media information that is selected and corresponding to the second pane identifier information or the conference site identifier information of the second conference site is synchronously displayed in the second pane of the display area of the recording server.

For example, when the recording server has an audio and video output device, the recording server may directly play the at least one channel of the streaming media information that is selected. Alternatively, the user may copy the at least one channel of the streaming media information or send the information to another private device of the user using a data interface of the recording server.

S310: The user terminal receives the combination data stream sent by the recording server, where the combination data stream includes the at least one channel of the streaming media information that is selected, and each of the at least one channel of the streaming media information is corresponding to one conference site.

S311: The user terminal displays the at least one channel of the streaming media information that is received.

When the streaming media identifier information includes identifier information of a first pane or conference site identifier information of a first conference site corresponding to the first pane, first streaming media information that is received and corresponding to the identifier information of the first pane or the conference site identifier information of the first conference site is displayed in the first pane of the display area of the user terminal; or when the streaming media identifier information is identifier information of a first pane or conference site identifier information of a first conference site corresponding to the first pane, first streaming media information that is received and corresponding to the identifier information of the first pane or the conference site identifier information of the first conference site is displayed in the display area of the user terminal; or when the streaming media identifier information includes identifier information of a first pane or conference site identifier information of a first conference site corresponding to the first pane, and second pane identifier information or conference site identifier information of a second conference site corresponding to a second pane, first streaming media information that is received and corresponding to the identifier information of the first pane or the conference site identifier information of the first conference site is displayed in the first pane of the display area of the user terminal; and second streaming media information that is received and corresponding to the second pane identifier information or the conference site identifier information of the second conference site is synchronously displayed in the second pane of the display area of the user terminal.

S312: The user terminal forwards the combination data stream to at least one other user terminal.

According to the video conference recording method provided in the embodiment of the present invention, a playback request message input by a user is received, and the playback request message is sent to a recording server; the recording server can select streaming media information according to the playback request message; and after receiving a combination data stream sent by the recording server, a user terminal displays at least one channel of streaming media information that is received, where the combination data stream includes the at least one channel of the streaming media information, and each of the at least one channel of the streaming media information is corresponding to one conference site. When recording and playback of a video conference are performed using the method, recording and playback of a video of the conference can be implemented according to a user requirement when the video conference is in progress, thereby improving user experience.

During a process of multiple user terminals actually performing a video conference, a pane of a screen of each user terminal may display a real-time video shot by a user terminal of another conference site. Each pane has a progress bar indicating a time progress. A location in which the progress bar is located is a current data location. A user may request, by operating the progress bar, the recording server to record and play back historical video information.

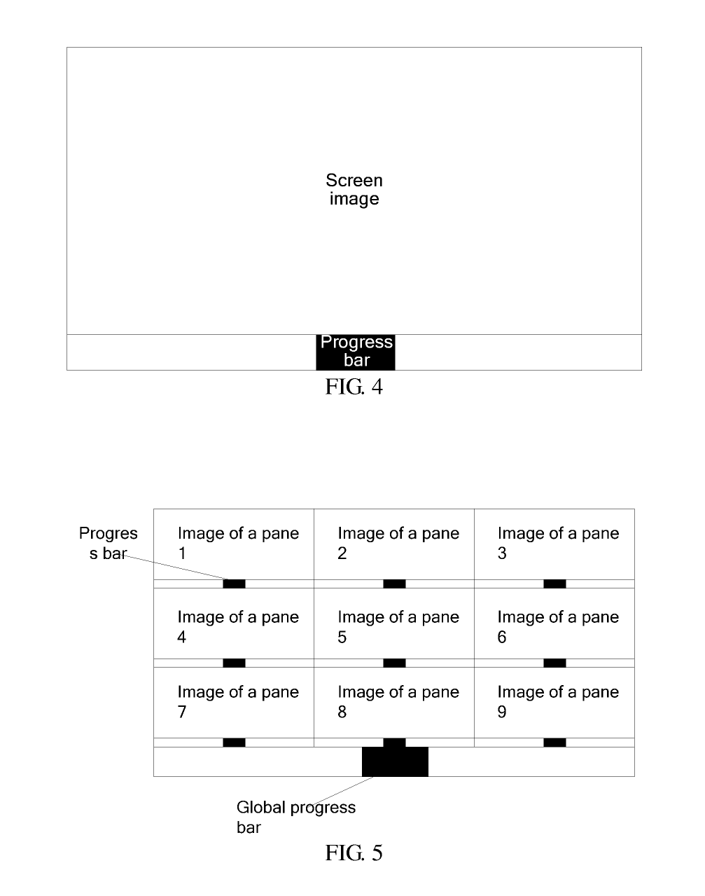

For example, when the user terminal participating in the video conference includes only two user terminals: a local user terminal and a user terminal located in a remote conference site, a screen of the local user terminal displays only an image of the other conference site. As shown in FIG. 4, an image displayed on the screen of the local user terminal is a real-time image of the other conference site, a progress bar indicating time is in a lower part of the image, and a location in which the progress bar is located is a current time point.

When wanting to view a historical video image of the other conference site, the user may drag the progress bar to the left to a desired historical moment, so that the local user terminal determines that the user has entered a playback request message.

The local user terminal sends the request message to the recording server, and the recording server selects, according to the request message, corresponding streaming media information stored on the recording server, performs adaptation processing on the selected streaming media information, and sends a historical video image obtained after the adaptation processing to the local user terminal.

The local user terminal decodes the received streaming media information, and displays decoded streaming media information on the screen of the local user terminal. The streaming media information may include at least one type of the following information: video information, audio information, image information, and subtitle information. For example, when the user drags the progress bar to view the historical video image of the other conference site, voice and subtitles are also played with dragging by the user.

For another example, when the user terminal participating in the video conference includes user terminals located in multiple conference sites, as shown in FIG. 5, a screen of a local user terminal is divided into 9 different display panes, which respectively display real-time images of a conference site 1 to a conference site 9. A progress bar indicating time of each pane is in a lower part of each pane, and a global progress bar indicating overall time is in a lower part of an overall screen.

When wanting to view a historical video image of all other conference sites, the user may drag the global progress bar to the left to a desired historical moment, so that the local user terminal determines that the user has entered a playback request message.

The local user terminal sends the request message to the recording server. The recording server selects, according to the request message, corresponding multiple channels of streaming media information stored on the recording server, and the recording server may combine the multiple channels of streaming media information into a combination data stream, and send the combination data stream to the local user terminal.

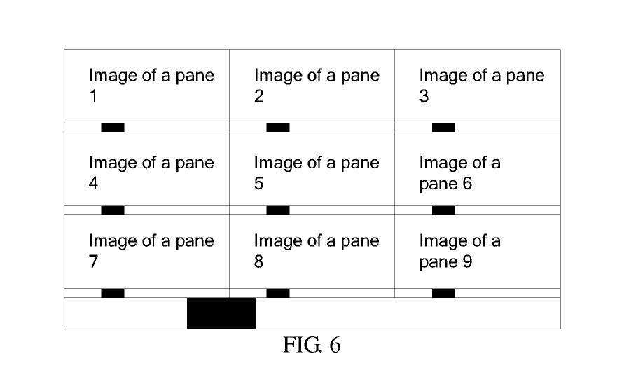

The local user terminal decodes the received combination data stream, and displays the combination data stream after decoding on the screen of the local user terminal, and each pane displays a historical image of a same historical moment of a corresponding conference site. As shown in FIG. 6, when the user drags the global progress bar to the left, progress bars of all the panes uniformly move with the global progress bar. The streaming media information may include at least one type of the following information: video information, audio information, image information, and subtitle information.

Alternatively, when wanting to view a historical video image of a specific conference site among other conference sites, the user may drag a progress bar of a pane corresponding to the conference site to the left to a desired historical moment, so that the local user terminal determines that the user has entered a playback request message. FIG. 5 is used as an example, where when wanting to view a historical video image of a conference site 6, the user may drag a progress bar of a pane 6 to the left.

The local user terminal sends the request message to the recording server. The recording server selects, according to the request message, corresponding multiple channels of streaming media information stored on the recording server, and the recording server may combine the multiple channels of streaming media information into a combination data stream, and send the combination data stream to the local user terminal. In the combination data stream, the pane 6 has been configured as the historical video image of the conference site 6 that is requested by the user, and panes corresponding to other conference sites remain unchanged.

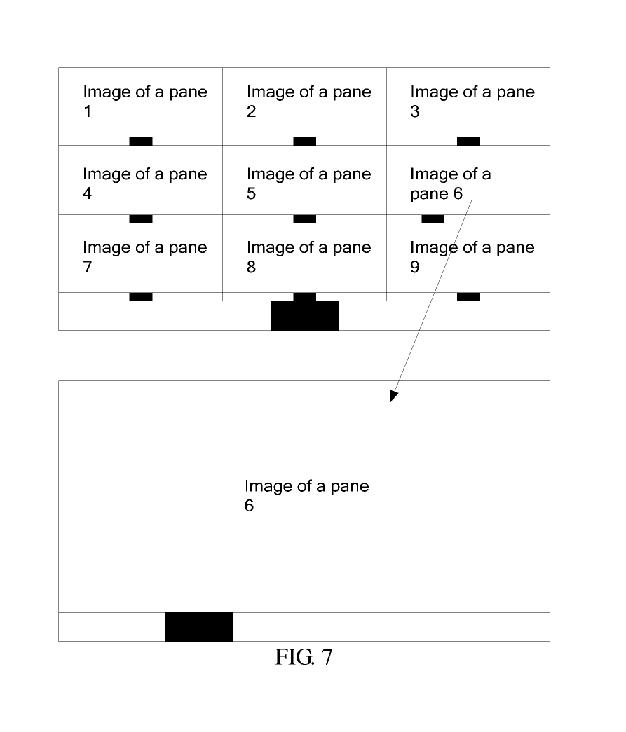

An image displayed on the screen of the local user terminal may be shown in FIG. 7, where the streaming media information may include at least one type of the following information: video information, audio information, image information, and subtitle information. The progress bar of the pane 6 is at a historical moment selected by the user, the pane 6 displays the historical image of the conference site 6, and other panes remain unchanged. The user may further enlarge the pane 6 to play at full screen, as show in FIG. 7. In this way, user experience can be further improved.

Alternatively, when wanting to view historical video images of multiple specific conference sites among other conference sites, the user may drag progress bars of panes corresponding to the conference sites to the left to a desired historical moment; or the user may select multiple panes for pane association, and when the user drags a progress bar of one pane, progress bars of other associated panes move correspondingly. FIG. 5 is also used as an example, where a pane 1 and a pane 2 are associated panes, and when wanting to view historical video images of a conference site 1 and a conference site 2 at the same time, the user may drag a progress bar of the pane 1 or the pane 2 to the left.

The local user terminal sends the request message to the recording server. The recording server selects, according to the request message, corresponding multiple channels of streaming media information stored on the recording server, and the recording server may combine the multiple channels of streaming media information into a combination data stream, and send the combination data stream to the local user terminal. In the combination data stream, the pane 1 and the pane 2 have been configured as the historical video images requested by the user, and panes corresponding to other conference sites remain unchanged.

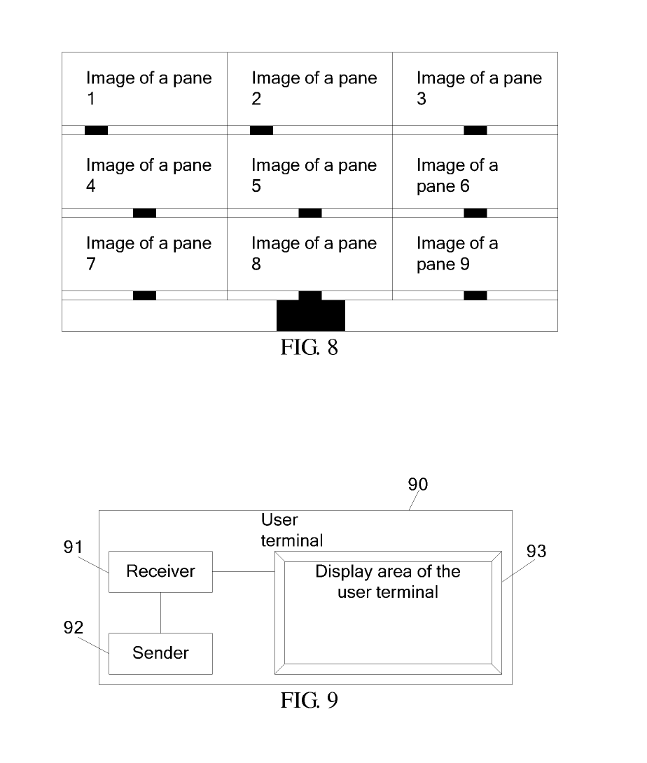

An image displayed on the screen of the local user terminal may be shown in FIG. 8, where the streaming media information may include at least one type of the following information: video information, audio information, image information, and subtitle information. The progress bars of the pane 1 and the pane 2 are at a historical moment selected by the user, the pane 1 and the pane 2 display the historical images of the conference site 1 and the conference site 2 respectively, and other panes remain unchanged.

Further, after receiving streaming media information of historical video images of other conference sites that is sent by the recording server, the local user terminal may further forward the streaming media information to user terminals of other conference sites that participate in the conference, so that the other conference sites can also refer to the recording and playback.

According to the video conference recording method provided in the embodiment of the present invention, a playback request message input by a user is received, and the playback request message is sent to a recording server; the recording server can select streaming media information according to the playback request message; and after receiving a combination data stream sent by the recording server, a user terminal displays at least one channel of streaming media information that is received, where the combination data stream includes the at least one channel of the streaming media information, and each of the at least one channel of the streaming media information is corresponding to one conference site. When recording and playback of a video conference are performed using the method, recording and playback of a video of the conference can be implemented according to a user requirement when the video conference is in progress, thereby improving user experience.

A user terminal 90 provided in an embodiment of the present invention is corresponding to the foregoing method embodiments, and can be used in all steps of the foregoing method embodiments. Detailed steps of the methods corresponding to the user terminal 90 have been described in the foregoing method embodiments, and are not detailed herein. As shown in FIG. 9, the user terminal 90 includes a receiver 91 configured to receive a playback request message input by a user; a sender 92 configured to send the playback request message to a recording server, so that the recording server selects recorded streaming media information according to the playback request message, where the receiver 91 is further configured to receive a combination data stream sent by the recording server, where the combination data stream includes at least one channel of the streaming media information that is selected, and each of the at least one channel of the streaming media information is corresponding to one conference site; and a display area 93 of the user terminal configured to display the streaming media information included in the received combination data stream.

According to the video conference user terminal provided in the embodiment of the present invention, a playback request message input by a user is received, and the playback request message is sent to a recording server; the recording server can select streaming media information according to the playback request message; and after receiving a combination data stream sent by the recording server, a user terminal displays at least one channel of streaming media information that is received, where the combination data stream includes the at least one channel of the streaming media information, and each of the at least one channel of the streaming media information is corresponding to one conference site. When recording and playback of a video conference are performed using the method, recording and playback of a video of the conference can be implemented according to a user requirement when the video conference is in progress, thereby improving user experience.

Further, before receiving the playback request message input by the user, the receiver 91 may be further configured to receive streaming media identifier information sent by the recording server.

When a state of a conference site changes, the sender 92 may be further configured to send conference information to the recording server, so that the recording server updates the streaming media identifier information.

The conference information may include conference site information and media indication information of each conference site.

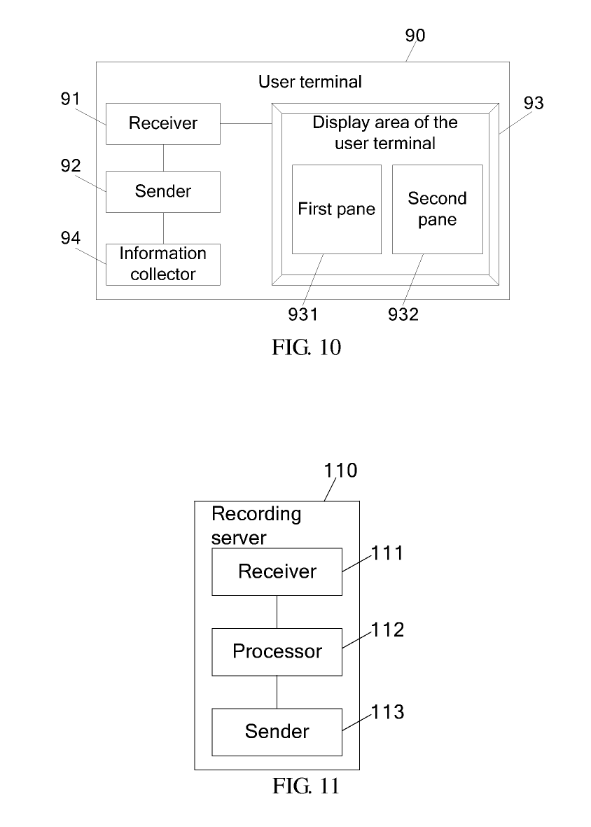

Further, as shown in FIG. 10, the user terminal 90 may further include an information collector 94 configured to collect an image and voice of a conference site accommodating the user, to obtain streaming media information.

The sender 92 may be further configured to send the streaming media information to the recording server.

Further, after the combination data stream sent by the recording server is received, the sender 92 may be further configured to forward the combination data stream to at least one other user terminal.

The receiver 91 may be further configured to receive the playback request message input by the user in the display area 93 of the user terminal.

The display area 93 of the user terminal may include at least one pane, and each pane is used to display a real-time image of one conference site.

Further, the playback request message may include streaming media identifier information and playback location information, where the streaming media identifier information may further include conference site identifier information of a conference site that participates in a conference or pane identifier information corresponding to the conference site that participates in the conference. The recording server may select a conference site whose streaming media information requires playback according to the streaming media identifier information and select, according to the playback location information, streaming media information that requires playback from recorded streaming media information of the conference site.

The streaming media identifier information may include identifier information of at least one pane.

The display area 93 of the user terminal may be further configured to, when the streaming media identifier information includes identifier information of a first pane or conference site identifier information of a first conference site corresponding to the first pane, display, in the first pane 931 of the display area 93 of the user terminal, first streaming media information that is received and corresponding to the identifier information of the first pane or the conference site identifier information of the first conference site; or when the streaming media identifier information is identifier information of a first pane or conference site identifier information of a first conference site corresponding to the first pane, display, in the display area 93 of the user terminal, first streaming media information that is received and corresponding to the identifier information of the first pane or the conference site identifier information of the first conference site; or when the streaming media identifier information includes identifier information of a first pane or conference site identifier information of a first conference site corresponding to the first pane, and second pane identifier information or conference site identifier information of a second conference site corresponding to a second pane, display, in the first pane 931 of the display area 93 of the user terminal, first streaming media information that is received and corresponding to the identifier information of the first pane or the conference site identifier information of the first conference site; and synchronously display, in the second pane 932 of the display area 93 of the user terminal, second streaming media information that is received and corresponding to the second pane identifier information or the conference site identifier information of the second conference site.

The streaming media information may include at least one type of the following information: video information, audio information, image information, and subtitle information.

A recording server 110 provided in an embodiment of the present invention is corresponding to the foregoing method embodiments, and can be used in all steps in the foregoing method embodiments. Detailed steps of the methods corresponding to the recording server 110 have been described in the foregoing method embodiments, and are not detailed herein. As shown in FIG. 11, the recording server 110 includes a receiver 111 configured to obtain a playback request message; a processor 112 configured to select streaming media information according to the playback request message, where the processor 112 is further configured to combine at least one channel of the streaming media information that is selected into a combination data stream, where each of the at least one channel of the streaming media information is corresponding to one conference site; and a sender 113 configured to send the combination data stream to at least one user terminal.

According to the video conference recording server provided in the embodiment of the present invention, a playback request message input by a user is received, and the playback request message is sent to a recording server; the recording server can select streaming media information according to the playback request message; and after receiving a combination data stream sent by the recording server, a user terminal displays at least one channel of streaming media information that is received, where the combination data stream includes the at least one channel of the streaming media information, and each of the at least one channel of the streaming media information is corresponding to one conference site. When recording and playback of a video conference are performed using the method, recording and playback of a video of the conference can be implemented according to a user requirement when the video conference is in progress, thereby improving user experience.

Further, before receiving the playback request message sent by the at least one user terminal, the receiver 111 may be further configured to receive streaming media identifier information input by the user.

The sender 113 may be further configured to send the streaming media identifier information to the at least one user terminal.

When a state of a conference site changes, the receiver 111 may be further configured to receive conference information sent by the at least one user terminal, where the conference information may include conference site information and media indication information of each conference site.

The processor 112 may update the streaming media identifier information according to the conference information.

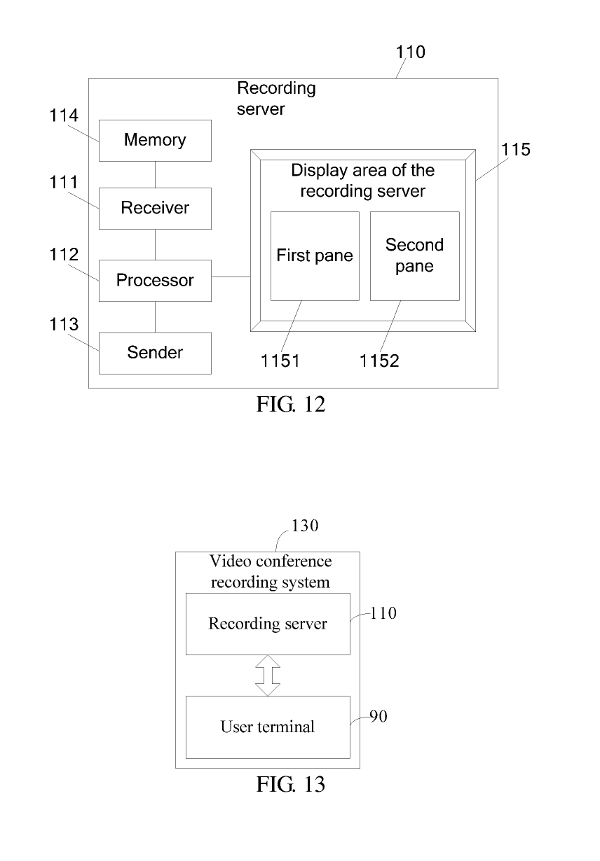

Further, as shown in FIG. 12, the recording server 110 may further include a memory 114 configured to receive and store the streaming media information sent by the at least one user terminal.

After the streaming media information is selected according to the playback request message, the recording server 110 may further include a display area 115 of the recording server configured to display the at least one channel of the streaming media information that is selected.

Further, the receiver 111 may be further configured to receive a playback request message sent by the at least one user terminal; or obtain a playback request message input by the user in the display area of the recording server, where the display area 115 of the recording server may include at least one pane, and each pane is used to display a real-time image of one conference site.

The playback request message may include streaming media identifier information and playback location information, where the streaming media identifier information may further include conference site identifier information of a conference site that participates in a conference or pane identifier information corresponding to the conference site that participates in the conference. The recording server may select a conference site whose streaming media information requires playback according to the streaming media identifier information and select, according to the playback location information, streaming media information that requires playback from recorded streaming media information of the conference site.

Further, the display area 115 of the recording server may be further configured to, when the streaming media identifier information includes identifier information of a first pane or conference site identifier information of a first conference site corresponding to the first pane, display, in the first pane 1151 of the display area 115 of the recording server, first streaming media information that is selected and corresponding to the identifier information of the first pane or the conference site identifier information of the first conference site; or when the streaming media identifier information is identifier information of a first pane or conference site identifier information of a first conference site corresponding to the first pane, display, in the display area 115 of the recording server, first streaming media information that is selected and corresponding to the identifier information of the first pane or the conference site identifier information of the first conference site; or when the streaming media identifier information includes identifier information of a first pane or conference site identifier information of a first conference site corresponding to the first pane, and second pane identifier information or conference site identifier information of a second conference site corresponding to a second pane, display, in the first pane 1151 of the display area 115 of the recording server, first streaming media information that is selected and corresponding to the identifier information of the first pane or the conference site identifier information of the first conference site; and synchronously display, in the second pane 1152 of the display area 115 of the recording server, second streaming media information that is selected and corresponding to the second pane identifier information or the conference site identifier information of the second conference site.

The streaming media information may include at least one type of the following information: video information, audio information, image information, and subtitle information.

An embodiment of the present invention further provides a video conference recording system 130, which, as shown in FIG. 13, includes at least one user terminal 90 as stated above, and the foregoing recording server 110.

Structures of the user terminal 90 and the recording server 110 have been described in detail in the foregoing embodiments, and details are not described herein again.

According to the video conference recording system provided in the embodiment of the present invention, a playback request message input by a user is received, and the playback request message is sent to a recording server; the recording server can select streaming media information according to the playback request message; and after receiving a combination data stream sent by the recording server, a user terminal displays at least one channel of streaming media information that is received, where the combination data stream includes the at least one channel of the streaming media information, and each of the at least one channel of the streaming media information is corresponding to one conference site. When recording and playback of a video conference are performed using the method, recording and playback of a video of the conference can be implemented according to a user requirement when the video conference is in progress, thereby improving user experience.

A person of ordinary skill in the art may understand that all or a part of the steps of the method embodiments may be implemented by a program instructing relevant hardware. The program may be stored in a computer readable storage medium. When the program runs, the steps of the method embodiments are performed. The foregoing storage medium includes any medium that can store program code, such as a read-only memory (ROM), a random access memory (RAM), a magnetic disk, or an optical disc.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A video conference recording method comprising:
receiving, by a user terminal, a playback request message input by a user;
sending, by the user terminal, the playback request message to a recording server, so that the recording server selects recorded streaming media information according to the playback request message;
receiving, by the user terminal, a combination data stream sent by the recording server, wherein the combination data stream comprises at least one channel of the streaming media information that is selected, and wherein each of the at least one channel of the streaming media information is corresponding to one conference site; and
displaying, by the user terminal, the streaming media information that is part of the received combination data stream.

2. The method according to claim 1, wherein receiving, by the user terminal, the playback request message input by the user comprises receiving, by the user terminal, the playback request message input by the user in a display area of the user terminal, wherein the display area of the user terminal comprises at least one pane, and wherein each of the at least one pane is used to display an image of the one conference site.

3. The method according to claim 1, wherein the playback request message comprises streaming media identifier information and playback location information, wherein, the streaming media identifier information is used by the recording server to select a conference site whose streaming media information requires playback, and wherein the playback location information is used by the recording server to select the streaming media information that requires playback from the recorded streaming media information of the conference site.

4. The method according to claim 3, wherein displaying the streaming media information that is part of the received combination data stream comprises displaying, in a first pane of a display area of the user terminal, first streaming media information that is received and corresponds to the identifier information of the first pane or conference site identifier information of a first conference site, when the streaming media identifier information comprises identifier information of the first pane or the conference site identifier information of the first conference site corresponding to the first pane.

5. The method according to claim 3, wherein displaying the streaming media information that is part of the received combination data stream comprises:
displaying, in a first pane of a display area of the user terminal, first streaming media information that is received and corresponding to identifier information of a first pane or conference site identifier information of a first conference site, when the streaming media identifier information comprises the identifier information of the first pane or the conference site identifier information of the first conference site corresponding to the first pane, and second pane identifier information or conference site identifier information of a second conference site corresponding to a second pane; and
synchronously displaying, in the second pane of the display area of the user terminal, second streaming media information that is received and corresponding to the second pane identifier information or the conference site identifier information of the second conference site.

6. The method according to claim 1, wherein the streaming media information comprises at least one type of the following information: video information, audio information, image information, and subtitle information.

7. A video conference recording method comprising:
obtaining, by a recording server, a playback request message;
selecting, by the recording server, streaming media information according to the playback request message;
combining, by the recording server, at least one channel of the streaming media information that is selected into a combination data stream, wherein each of the at least one channel of the streaming media information is corresponding to one conference site; and
sending, by the recording server, the combination data stream to at least one user terminal.

8. The method according to claim 7, wherein obtaining, by the recording server, the playback request message comprises receiving, by the recording server, the playback request message sent by the at least one user terminal.

9. The method according to claim 7, wherein obtaining, by the recording server, the playback request message comprises obtaining, by the recording server, the playback request message input by a user in a display area of the recording server, wherein the display area of the recording server comprises at least one pane, and wherein each of the at least one pane is used to display an image of one conference site.

10. The method according to claim 7, wherein the playback request message comprises streaming media identifier information and playback location information, and wherein selecting, by the recording server, streaming media information according to the playback request message comprises:
selecting, by the recording server, a conference site whose streaming media information requires playback according to the streaming media identifier information; and
selecting, by the recording server, according to the playback location information, the streaming media information that requires playback from recorded streaming media information of the conference site.

11. The method according to claim 7, wherein the streaming media information comprises at least one type of the following information: video information, audio information, image information, and subtitle information.

12. A user terminal comprising:
a receiver configured to receive a playback request message input by a user;
a sender configured to send the playback request message to a recording server, so that the recording server selects recorded streaming media information according to the playback request message, wherein the receiver is further configured to receive a combination data stream sent by the recording server, wherein the combination data stream comprises at least one channel of the streaming media information that is selected, wherein each of the at least one channel of the streaming media information is corresponding to one conference site, and wherein a display area of the user terminal configured to display the streaming media information that is part of the received combination data stream.

13. The user terminal according to claim 12, wherein the receiver is further configured to receive the playback request message input by the user in the display area of the user terminal, wherein the display area of the user terminal comprises at least one pane, and wherein each of the at least one pane is used to display an image of one conference site.

14. The user terminal according to claim 12, wherein the playback request message comprises streaming media identifier information and playback location information, wherein, the streaming media identifier information is used by the recording server to select a conference site whose streaming media information requires playback, and wherein the playback location information is used by the recording server to select the streaming media information that requires playback from recorded streaming media information of the conference site.

15. The user terminal according to claim 14, wherein the display area of the user terminal is further configured to display, in a first pane of the display area of the user terminal, first streaming media information that is received and corresponding to identifier information of the first pane or conference site identifier information of a first conference site when the streaming media identifier information comprises the identifier information of the first pane or the conference site identifier information of the first conference site corresponding to the first pane.

16. The user terminal according to claim 14, wherein the display area of the user terminal is further configured to:
display, in a first pane of the display area of the user terminal, first streaming media information that is received and corresponding to identifier information of the first pane or conference site identifier information of a first conference site, when the streaming media identifier information comprises the identifier information of the first pane or the conference site identifier information of the first conference corresponding to the first pane, and second pane identifier information or conference site identifier information of a second conference site corresponding to a second pane; and
synchronously display, in the second pane of the display area of the user terminal, second streaming media information that is received and corresponding to the second pane identifier information or the conference site identifier information of the second conference site.

17. A recording server comprising:
a receiver configured to obtain a playback request message;
a processor configured to select streaming media information according to the playback request message, wherein the processor is further configured to combine at least one channel of the streaming media information that is selected into a combination data stream, wherein each of the at least one channel of the streaming media information is corresponding to one conference site, and wherein a sender configured to send the combination data stream to at least one user terminal.

18. The recording server according to claim 17, wherein the receiver is further configured to receive the playback request message sent by the at least one user terminal.

19. The recording server according to claim 17, wherein the receiver is further configured to obtain the playback request message input by a user in a display area of the recording server, wherein the display area of the recording server comprises at least one pane, and wherein each of the at least one pane is used to display an image of one conference site.

20. The recording server according to claim 17, wherein the playback request message comprises streaming media identifier information and playback location information, wherein the streaming media identifier information comprises conference site identifier information of a conference site that participates in a conference or pane identifier information corresponding to the conference site that participates in the conference, and wherein the processor is configured to:
select a conference site whose streaming media information requires playback according to the streaming media identifier information; and
select, according to the playback location information, the streaming media information that requires playback from recorded streaming media information of the conference site.
